(19) United States
(12) Patent Application Publication
(10) Pub. No.: US 2014/0244504 A1
(43) Pub. Date: Aug. 28, 2014

(54) METHODS AND SYSTEMS FOR PROCESSING ELECTRONIC TRANSACTIONS AND MANAGING VEHICLE COSTS

(71) Applicant: MASTERCARD INTERNATIONAL INCORPORATED, Purchase, NY (US)

(72) Inventor: Trevor Scott Owen, O'Fallon, MO (US)

(73) Assignee: MASTERCARD INTERNATIONAL INCORPORATED, Purchase, NY (US)

(21) Appl. No.: 13/779,007

(22) Filed: Feb. 27, 2013

(51) Int. Cl. G06Q 20/36

(52) U.S. Cl. CPC G06Q 20/36
USPC 705/44

(57) ABSTRACT

A computer-implemented method for performing an electronic transaction over a payment network system is provided. The transaction is initiated by a cardholder using a cardholder computer device in communication with a merchant computer device of a merchant, wherein the cardholder computer device is associated with a vehicle. The method includes receiving first merchant data at the cardholder computer device when the vehicle is located within a predetermined distance of the merchant computer device. The cardholder is prompted to select a purchase item from first merchant data. The method includes transmitting purchase data including at least one of an account data and a purchase item data to the merchant computer device, wherein the merchant computer device is configured to generate a payment authorization request message. The cardholder computer device receives a confirmation message in response to the authorization request message.

### BACKGROUND OF THE DISCLOSURE

This invention relates generally to systems and methods for performing an electronic transaction and, more particularly, to network-based systems and methods for processing and tracking electronic transactions relating to a vehicle wherein the transaction is initiated by a cardholder having a transaction account.

Electronic transaction cards are widely used in the United States and elsewhere as a means to attract financial accounts to financial institutions and, in the case of credit cards, as a medium to create small loans and generate interest income for financial institutions.

Some vehicle models include electronic capabilities such as accessing the Internet and accessing satellite navigation systems. These capabilities can be available in vehicles through OEM and/or aftermarket integrated user interface devices. Some of the interface devices merge hands free telephony with access to Internet/satellite web service. Typical electronic capabilities provide pre-set data to the vehicle such as downloadable music. Other electronic capabilities provide directions to a particular location. Consumers, however, may desire to know information about a particular location while driving their vehicle in an area. More particularly, consumers may desire to know menus of local restaurants, retail items of local shops and available services from local gas stations. Stopping at multiple establishments and walking into the respective establishments to view items is not desirable since, sometimes, these time-consuming activities are conducted in inclement weather such as rain, snow and heat.

Accordingly, a system and method is needed that utilizes protocols for communicating information between vehicle computer devices, merchant computer devices, payment processing computer devices, and other third party devices in order to enhance and further automate processing and tracking vehicle transactions and payments.

### BRIEF DESCRIPTION OF THE INVENTION

In one aspect, a computer-implemented method for performing an electronic transaction over a payment network system is provided. The payment network system includes a server system coupled to a memory device. The transaction is initiated by a cardholder using a cardholder computer device in communication with a merchant computer device of a merchant, wherein the cardholder computer device is associated with a vehicle. The method includes receiving first merchant data at the cardholder computer device when the vehicle is located within a predetermined distance of the merchant computer device, wherein the first merchant data includes a plurality of items offered for sale by the merchant. The method includes displaying at least some of the first merchant data on a user display coupled to the cardholder computer device. The cardholder is prompted to select a purchase item from the plurality of items and receive account data at the cardholder computer device. The method includes transmitting purchase data including at least one of an account data and a purchase item data to the merchant computer device, wherein the merchant computer device is configured to generate a payment authorization request message for providing to an issuing bank based at least in part on the purchase data. The cardholder computer device receives a confirmation message in response to the authorization request message confirming that the issuing bank authorized the transaction.

In another aspect, a computer-implemented method for performing an electronic transaction over a payment network system is provided. The payment network system includes a server system coupled to a memory device, wherein the transaction is initiated by a cardholder using a cardholder computer device in communication with a merchant computer device of a merchant. The method includes receiving, at the server system, a transmission of a location signal of the cardholder computer device and associating, at the server system, the location signal of the cardholder computer device with a plurality of merchant data stored within the database of the interchange computer. The method includes transmitting a first merchant data of the plurality of merchant data from the interchange computer to the cardholder computer device. An authorization request message is received by the server system from a merchant associated with the first merchant data, wherein the authorization request message includes the first merchant data and an account data. The method includes transmitting an authorization response message from the server system to the merchant associated with the first merchant data and storing the first merchant data and the account data.

In still another aspect, a vehicle computer device integrated with a vehicle for performing an electronic transaction over a payment network system is provided. The payment network system includes a server system coupled to a memory device, wherein the transaction is initiated by a cardholder using the vehicle computer device in communication with a merchant computer device of a merchant. The vehicle computer device is programmed to receive the first merchant data when the vehicle is located within a predetermined distance of the merchant computer device, wherein the first merchant data includes a plurality of items offered for sale by the merchant. The vehicle computer device is programmed to display at least some of the first merchant data on a user display coupled to the vehicle computer device. The cardholder is prompted to select a purchase item from the plurality of items and receive account data associated with the cardholder. Further, the vehicle computer device is programmed to transmit purchase data including at least one of an account data and a purchase item data to the merchant computer device, wherein the merchant computer device is configured to generate a payment authorization request message for providing to an issuing bank based at least in part on the purchase data. The vehicle computer program is programmed to receive a confirmation message in response to the authorization request message confirming that the issuing bank authorized the transaction.

In yet another aspect, one or more non-transitory computer-readable storage media having computer-executable instructions embodied thereon for performing an electronic transaction over a payment network system is provided. The payment network system includes a server system coupled to a database, wherein the transaction is initiated by a cardholder using a cardholder computer device in communication with a merchant computer device of a merchant. The cardholder computer device associated with a vehicle. The server system includes a memory device and a processor, wherein when executed by the processor, the computer-executable instructions cause the processor to receive a transmission of a location signal of the cardholder computer device and associate the location signal of the cardholder computer device with a plurality of merchant data stored within the database of the server system. The computer-executable instructions cause the processor to transmit a first merchant data of the plurality of merchant data from the server system to the cardholder computer device. Further, the computer-executable instructions cause the processor to receive an authorization request message from a merchant associated with the first merchant data, the authorization request message includes the first merchant data and an account data. Moreover, the computer-executable instructions cause the processor to transmit an authorization response message from the server system to the merchant associated with the first merchant data and store the first merchant data and the account data.

In another aspect, a system for performing an electronic transaction over a payment network system is provided. The payment network system includes a server system coupled to a memory device, wherein the transaction is initiated by a cardholder with a merchant computer device of a merchant. The system includes a vehicle computer device integrated with a vehicle and configured to receive a first merchant data when the vehicle is located within a predetermined distance of the merchant computer device. The first merchant data includes a plurality of items offered for sale by the merchant. The vehicle computer device is configured to display at least some of the first merchant data on a user display coupled to the vehicle computer device. The cardholder is promoted to select a purchase item from the plurality of items and receive account data associated with the cardholder. The vehicle computer device is configured to transmit purchase data including at least one of an account data and a purchase item data to the merchant computer device. The merchant computer device is configured to generate a payment authorization request message for providing to an issuing bank based at least in part on the purchase data and receive a confirmation message in response to the authorization request message confirming that the issuing bank authorized the transaction.

### BRIEF DESCRIPTION OF THE DRAWINGS

FIGS. 1-7 show example embodiments of the methods and systems described herein.

FIG. 1 is a schematic diagram illustrating a multi-party payment system for processing payment transactions using a payment card or payment account in accordance with one embodiment of the present invention;

FIG. 2 is a simplified block diagram of an example embodiment of a server architecture including a vehicle computer device for providing a vehicle cost management service in accordance with one embodiment of the present invention;

FIG. 3 is an expanded block diagram of an example embodiment of a server architecture of the payment account processing system for providing a vehicle cost management service shown in FIG. 2;

FIG. 4 illustrates an example configuration of a cardholder computer device operated by a user such as the computer devices shown in FIGS. 2 and 3;

FIG. 5 illustrates an example configuration of a server computer device such as the server system shown in FIGS. 2 and 3;

FIG. 6 is a block diagram of a system showing data flow between various computer devices in accordance with one embodiment of the present invention; and

FIG. 7 is a flowchart illustrating an example process for using a vehicle computer device when performing a transaction in accordance with one embodiment of the present invention.

### DETAILED DESCRIPTION OF THE DISCLOSURE

The methods and systems described herein relate to an electronic transaction card payment system, such as a credit card payment system using the MasterCard® interchange network (MasterCard is a registered trademark of MasterCard International Incorporated located in Purchase, N.Y.). The MasterCard® interchange network is a proprietary communications standard promulgated by MasterCard International Incorporated® for the exchange of electronic transaction data between financial institutions that have registered with MasterCard International Incorporated®.

The following detailed description illustrates embodiments of the invention by way of example and not by way of limitation. It is contemplated that the invention has general application to processing electronic transaction data by a third party in vehicular applications. As used herein, an element or step recited in the singular and proceeded with the word “a” or “an” should be understood as not excluding plural elements or steps, unless such exclusion is explicitly recited. Furthermore, references to “one embodiment” and/or “another embodiment” of the present invention are not intended to be interpreted as excluding the existence of additional embodiments that also incorporate the recited features.

As used herein, the term “transaction card” or “payment card” refers to any suitable transaction card, such as a credit card, a debit card, a membership card, a promotional card, a frequent flyer card, an identification card, a prepaid card, a gift card, and/or any other device that may hold payment account information, such as mobile phones, personal digital assistants (PDAs), and key fobs. The term “transaction card” or “payment card” can also refer to a bank account associated with a user or cardholder that is issued by an issuing bank whether or not a physical card is provided to the cardholder by the issuing bank.

The embodiments described herein are directed to systems and methods for performing a transaction using a vehicle computer device and tracking costs associated with a particular vehicle. The transaction is performed by a user of a transaction card. These users are referred to as cardholders. A cardholder is issued a transaction card by an issuer or an issuing bank. The cardholder is able to use the transaction card at participating merchants to initiate transactions. The merchant processes these transactions using a point-of-sale (POS) device and/or a point of interaction device that captures certain transaction information and communicates this information over an interchange network to a merchant bank and ultimately to the issuer. Information is then exchanged between these parties over the interchange network until the transaction is completed.

During operation, a cardholder receives merchant data from the merchant (e.g., directly or over the payment network system) and initiates a transaction with the merchant (e.g., directly or over the payment network system) via a cardholder computer device associated with the cardholder. In an example embodiment, the cardholder computer device is associated with the user's vehicle. In one embodiment, the cardholder computer device is integrated within the user's vehicle. More particularly, the cardholder computer device is a component of the user's vehicle and therefore may be referred to as a vehicle computer device. The vehicle computer device transmits purchase data, account data, and a vehicle identifier to the merchant computer device. More particularly, the cardholder transmits a purchase selection instruction from the vehicle computer device using an input device. This purchase selection instruction includes purchase data, which identifies an item (i.e., a product and/or service) offered for sale and/or offered for lease by the merchant and which the cardholder desires to purchase from the merchant. After the user has selected items for purchase, the vehicle computer device communicates the account data and the vehicle identifier to the merchant computer device. The merchant computer then generates an authorization request message and transmits the authorization request message to the payment computer system.

Upon receipt of the payment authorization request message, the payment computer system may prompt the cardholder to enter access credential information, such as, but not limited to, a username, a password, a security token, and/or biometric data. In one embodiment, the payment computer system receives a request that originates at the vehicle computer device and is forwarded to the payment computer system by the merchant computer. In another embodiment, the vehicle computer device is configured to access a web address (e.g., a uniform resource locator (URL)) associated with the payment computer system, and the payment computer system receives a transaction request directly from the vehicle computer device. In either embodiment, the payment computer system prompts the cardholder for credential access information through a user interface in communication with the vehicle computer device.

The cardholder enters the access credential information, and the payment computer system receives the access credential information from the vehicle computer device. The payment computer system verifies the access credential information. More particularly, the payment computer system compares the authorization response of the credential information and data associated with the cardholder with a cardholder database of the payment computer system. If the verification succeeds (e.g., the access credential information matches access credential information stored by and/or calculated by the payment computer system), the payment computer system prompts the cardholder for payment information for the current transaction.

In some embodiments, the payment computer system prompts the cardholder to select from one or more options indicating previously stored payment information. For example, the payment computer system may prompt the cardholder to select a transaction card from one or more transaction cards previously associated with the cardholder. The payment computer system may similarly prompt the cardholder to select any other payment information.

The payment computer system receives the payment information from the vehicle computer device either directly or through the merchant computer device. The payment computer system forwards the authorization request message to the issuing bank so that the issuing bank can determine whether to approve or decline the transaction. The issuing bank generates an authorization response message and transmits the authorization response message to the payment computer system. In one embodiment, the payment computer system receives a selected transaction card identifier from the vehicle computer device and retrieves an account number (e.g., a primary account number (PAN)), a security code (e.g., a CVC2 code and/or a personal identification number (PIN)), and/or an expiry date based on the selected transaction card identifier. The merchant computer device, or vehicle computer device, receives the authorization response message from the payment computer system so that the transaction can be completed.

A technical effect of the systems and methods described herein is achieved by performing at least one of the following steps: (a) receiving, at a cardholder computing device, first merchant data when a vehicle is located within a predetermined distance of a merchant computing device, wherein the first merchant data includes a plurality of items offered for sale by a merchant; (b) displaying at least some of the first merchant data on a user display coupled to the cardholder computing device; (c) prompting the cardholder to select a purchase item from the plurality of items; (d) receiving account data at the cardholder computing device; (e) transmitting, purchase data, including at least one of account data and purchase item data, to the merchant computing device, wherein the merchant computing device is configured to generate a payment authorization request message for providing to an issuing bank based at least in part on the purchase data; and (f) receiving, at the cardholder computing device, a confirmation message in response to the authorization request message confirming that the issuing bank authorized the transaction.

In one embodiment, a computer program is provided, and the program is embodied on a computer readable medium and utilizes a Structured Query Language (SQL) with a client user interface front-end for administration and a web interface for standard user input and reports. In an example embodiment, the system is web enabled and is run on a business-entity intranet. In yet another embodiment, the system is fully accessed by individuals having an authorized access outside the firewall of the business-entity through the Internet. In a further example embodiment, the system is executed in a Windows® environment (Windows is a registered trademark of Microsoft Corporation, Redmond, Wash.). In yet another embodiment, the system is executed in a mainframe environment and a UNIX® server environment (UNIX is a registered trademark of AT&T, New York, N.Y.). The application is flexible and designed to operate in different environments without compromising any major functionality.

The systems and processes described herein are not limited to the specific embodiments described herein. In addition, components of each system and each process can be practiced independent of and separate from other components and processes described herein. Each component and process also can be used in combination with other assembly packages and processes.

The following detailed description illustrates embodiments of the invention by way of example and not by way of limitation. It is contemplated that the invention has general application to processing electronic transaction data by a third party in industrial, commercial, and residential applications.

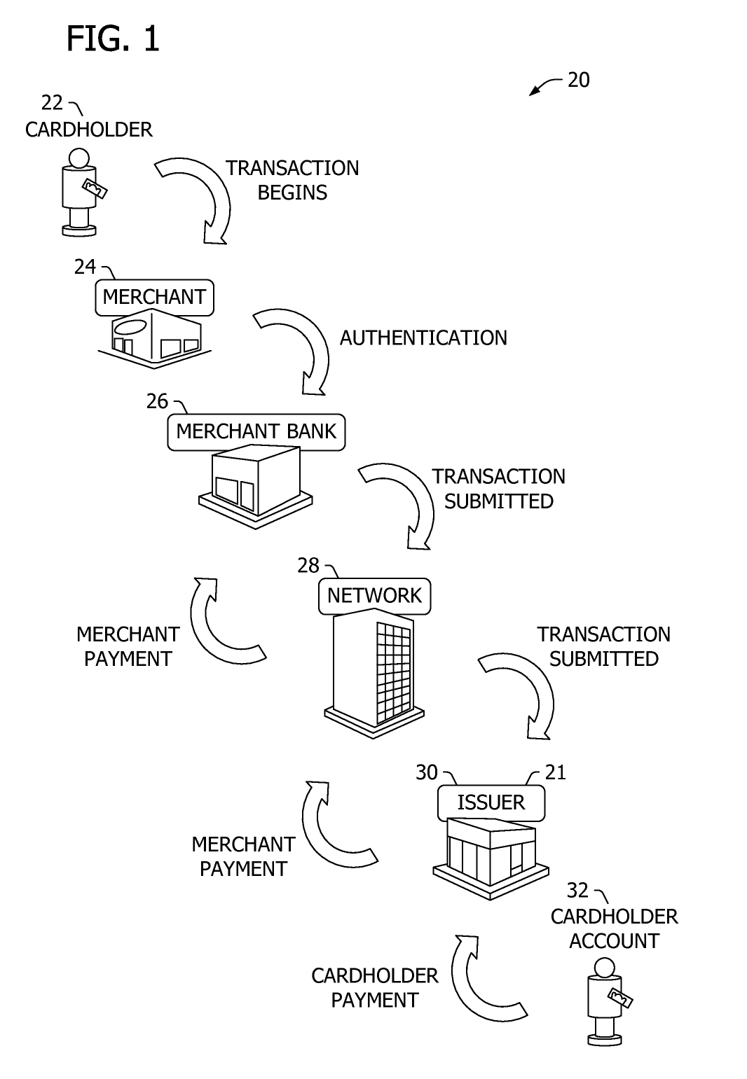

FIG. 1 is a schematic diagram illustrating a multi-party payment network system 20 for processing payment transactions using a payment card or payment account in accordance with one embodiment of the present invention. More particular, multi-party payment netowkr system 20 is illustrated for enabling payment-by-card transactions in which merchants and card issuers do not necessarily have a one-to-one relationship in accordance with one example embodiment of the invention. In the example embodiment, the payment network system 20 relates to a system, such as a credit card payment system using the MasterCard® payment system. The MasterCard® payment system is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In a typical payment network system 20, a financial institution such as issuer 21 issues a payment card, such as a credit card account or a debit card account, to a cardholder 22, who uses the payment card to tender payment for a purchase from a merchant 24. To accept payment with the payment card, merchant 24 must normally establish an account with a financial institution that is part of the financial payment system. This financial institution is usually called the “merchant bank” or the “acquiring bank” or “acquirer bank.” When a cardholder 22 tenders payment for a purchase with a payment card, merchant 24 requests authorization from merchant bank 26 for the amount of the purchase. The request may be performed over the telephone, but is usually performed through the use of a point-of-sale terminal, which reads the cardholder's account information from the magnetic stripe on the payment card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor” or an “acquiring processor.”

Using a network interface processor 28, the computers of the merchant bank or the merchant processor will communicate with the computers of issuer 30 to determine whether the cardholder's account is in good standing and whether the purchase is covered by the cardholder's available credit line or account balance. Based on these determinations, the request for authorization will be declined or accepted. If the request is accepted, an authorization code is issued to merchant 24.

When a request for authorization is accepted, the available credit line or available balance of cardholder's account 32 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 24 captures the transaction by, for example, appropriate data entry procedures on the point-of-sale terminal. If a cardholder cancels a transaction before it is captured, a “void” is generated. If a cardholder returns goods after the transaction has been captured, a “credit” is generated.

For debit card transactions, when a request for a PIN authorization is approved by the issuer, the cardholder's account 32 is decreased. Normally, a charge is posted immediately to cardholder's account 32. The bankcard association then transmits the approval to the acquiring processor for distribution of goods/services, or information or cash in the case of an ATM.

After a transaction is captured, the transaction is settled between merchant 24, merchant bank 26, and issuer 30. Settlement refers to the transfer of financial data or funds between the merchant's account, merchant bank 26, and issuer 30 related to the transaction. Usually, transactions are captured and accumulated into a “batch,” which is settled as a group.

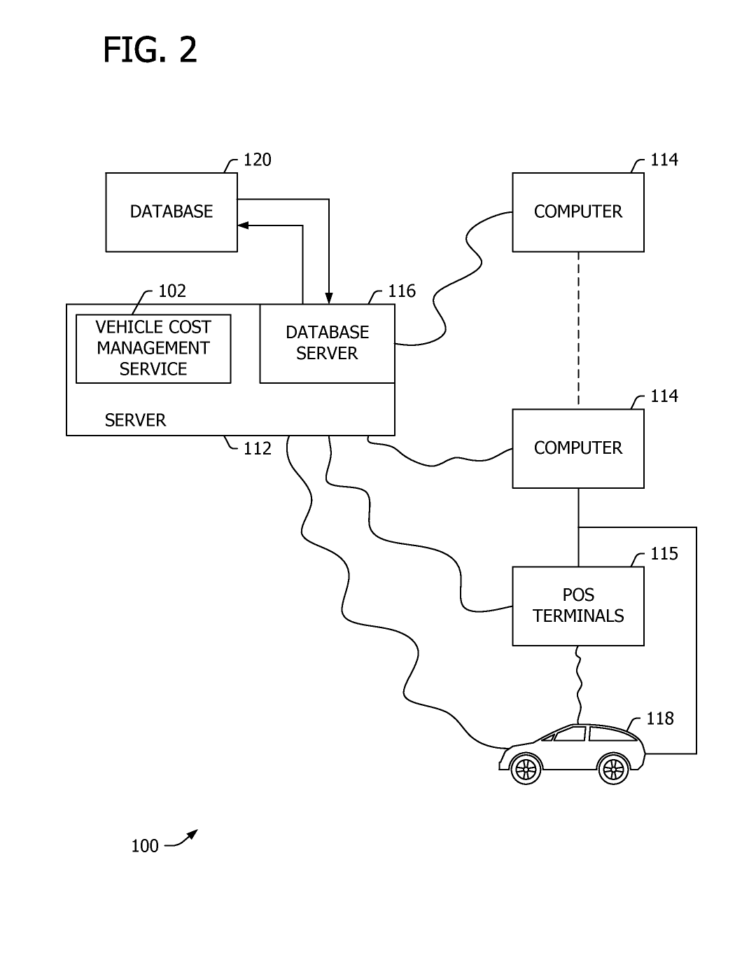

FIG. 2 is a simplified block diagram of an example payment account processing system 100 including a vehicle cost management service 102 in accordance with one embodiment of the present invention. System 100 can be utilized by cardholders as part of a process of initiating an authorization request and performing a transaction as described below. In addition, system 100 is a payment processing account system having a vehicle computer device 118, which a cardholder may use to access a merchant's website, conduct electronic transactions, and/or record payments for electronic transactions relative to vehicle costs. Vehicle computer device 118 also enables a cardholder to manage and track costs relating to the use and/or operation of the vehicle.

More specifically, in the example embodiment, system 100 includes a server system 112, which is a type of computer system, and a plurality of client sub-systems (also referred to as client systems 114) connected to server system 112. In one embodiment, client systems 114 are computers including a web browser and a memory device, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed ISDN lines. Client systems 114 could be any device capable of interconnecting to the Internet including a web-based phone, personal digital assistant (PDA), or other web-based connectable equipment.

System 100 also includes point-of-sale (POS) terminals 115, which are connected to client systems 114 and may be connected to server system 112. POS terminals 115 are interconnected to the Internet through many interfaces including a network, such as a local area network (LAN) or a wide area network (WAN), dial-in-connections, cable modems, wireless modems, and special high-speed ISDN lines. POS terminals 115 could be any device capable of interconnecting to the Internet and including an input device capable of reading information from a cardholder's financial transaction card.

A database server 116 is connected to a database 120, which contains information on a variety of matters, as described below in greater detail. In one embodiment, centralized database 120 is stored on server system 112 and can be accessed by cardholders at one of client systems 114 by logging onto server system 112 through one of client systems 114. In an alternative embodiment, database 120 is stored remotely from server system 112 and may be non-centralized. Database 120 may store transaction data generated as part of sales activities conducted over the bankcard network including data relating to merchants, account holders or customers, and purchases. Database 120 may also store account data including at least one of a cardholder name, a cardholder address, an account number, and other account identifiers. Database 120 may also store merchant data including a merchant identifier that identifies each merchant registered to use the payment account processing network, and instructions for settling transactions including merchant bank account information. Database 120 may also store PAN numbers or bank account numbers for various parties including merchants and customers, along with payment verification identifiers and other data necessary to implement the system and processes described herein.

System 100 also includes at least one vehicle computer device 118, which is configured to communicate with at least one of POS terminal 115, client systems 114, and server system 112. In one embodiment, vehicle computer device 118 is associated with or controlled by a cardholder making a purchase using a payment card account and payment account processing system 100. Vehicle computer device 118 is associated with a vehicle. In one embodiment, vehicle computer device 118 is integrated with the vehicle. More particularly, vehicle computer device 188 is a component of a vehicle and may therefore be referred to as a vehicle computer device. Vehicle computer device 118 is interconnected to the Internet through many interfaces including a network, such as a LAN or a WAN, dial-in-connections, cable modems, wireless modems, and special high-speed ISDN lines. Vehicle computer device 118 could be any device capable of interconnecting to the Internet including a web-based phone, PDA, or other web-based connectable equipment. Vehicle computer device 118 is configured to communicate with POS terminal 115 using various outputs including, for example, Bluetooth communication, radio frequency communication, near field communication, network-based communication, and the like.

In the example embodiment, one of client systems 114 may be associated with an acquirer, a cardholder, or a customer; while another one of client systems 114 may be associated with an issuer; POS terminal 115 may be associated with a merchant; vehicle computer device 118 may be associated with a cardholder or a customer; and server system 112 may be associated with the payment network or the interchange network.

In the example embodiment, server system 112 may be associated with a payment network, and may be referred to as a payment computer device. Server system 112 may be used for processing transaction data and for registering cardholders into a plurality of programs offered by the payment network. In addition, at least one of client systems 114 may include a computer system associated with an issuer of a transaction card. Accordingly, server system 112 and client systems 114 may be utilized to process transaction data relating to purchases made by a cardholder utilizing a transaction card that is processed by the payment network and issued by the associated issuer. Another client system 114 may be associated with a user or a cardholder seeking to register access information or process a transaction with at least one of the payment network, the issuer, the POS, or the merchant computer.

The embodiments illustrated and described herein as well as embodiments not specifically described herein but within the scope of aspects of the invention constitute example means for performing a financial transaction, and more particularly, constitute example means for performing a financial transaction using a vehicle computer device and tracking costs associated with a particular vehicle. For example, server system 112, POS terminal 115, client system 114, vehicle computer device 118, or any other similar computer device, programmed with computer-executable instructions to execute processes and techniques with a processor as described herein, constitutes example means for enabling a cardholder to manage and track costs relating to the operation of the particular vehicle using a vehicle computer device.

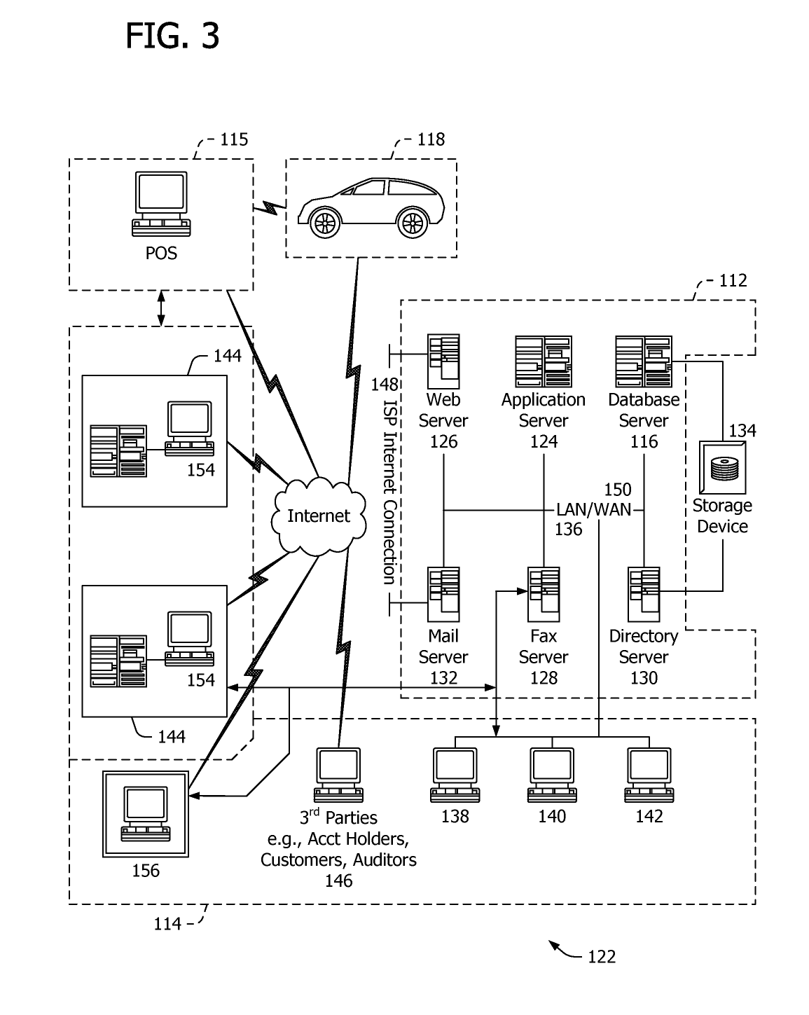

FIG. 3 is an expanded block diagram of an example embodiment of a server architecture of a payment card account system 122, such as an account processing system, for providing a vehicle cost management service as shown in FIG. 2. Components in system 122, identical to components of system 100 (shown in FIG. 2), are identified in FIG. 3 using the same reference numerals as used in FIG. 2. System 122 includes server system 112, client systems 114, POS terminals 115, and vehicle computer device 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a LAN 136. In addition, a system administrator's workstation 138, a cardholder's workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties 146, e.g., account holders, customers, auditors, etc., using an ISP Internet connection 148. The communication in one embodiment is illustrated as being performed using the Internet, however, any other WAN type communication can be utilized in other embodiments, i.e., the systems and processes are not limited to being practiced using the Internet. In addition, and rather than WAN 150, LAN 136 could be used in place of WAN 150.

In one embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other workstations 138, 140, and 142 as well.

As used herein, the terms “software” and “firmware” are interchangeable, and include any computer program stored in memory for execution by personal computers, workstations, clients and servers, including random access memory (RAM), read-only memory (ROM), erasable programmable ROM (EPROM), electrically erasable programmable ROM (EEPROM), and/or non-volatile RAM (NVRAM) memory. The above memory types are example only, and are thus not limiting as to the types of memory usable for storage of a computer program.

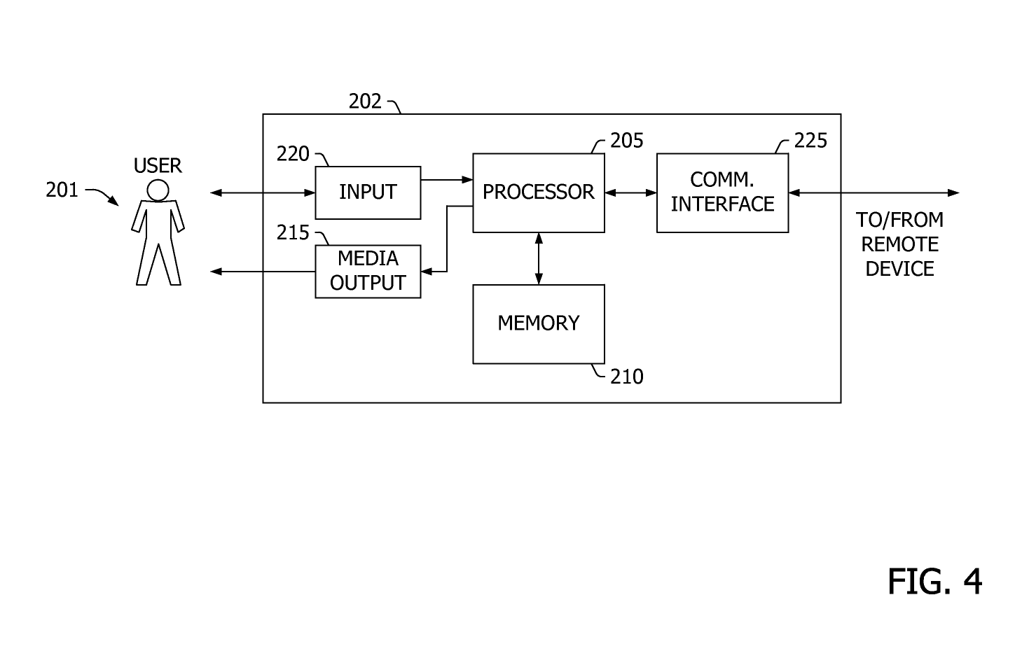

FIG. 4 illustrates an example configuration of a cardholder computer device 202 operated by a user 201. Cardholder computer device 202 may include, but is not limited to, client systems 114, 138, 140, and 142, POS terminal 115, vehicle computer device 118, workstation 154, and manager workstation 156 (shown in FIG. 3).

Cardholder computer device 202 includes a processor 205 for executing instructions. In some embodiments, executable instructions are stored in a memory area 210. Processor 205 may include one or more processing units (e.g., in a multi-core configuration). Memory area 210 is any device allowing information such as executable instructions and/or other data to be stored and retrieved. Memory area 210 may include one or more computer readable media.

Cardholder computer device 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computer device 202 includes an input device 220 for receiving input from user 201. User may use input device 220 to transmit purchase selection instructions to select and/or enter, without limitation, one or more goods and/or services to purchase, a purchase request, access credential information and/or payment information. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Cardholder computer device 202 may also include a communication interface 225, which is communicatively couplable to a remote device such as server system 112. Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable cardholders, such as user 201, to display and interact with media and other information typically embedded on a web page or a website from server system 112. A client application allows user 201 to interact with a server application from server system 112.

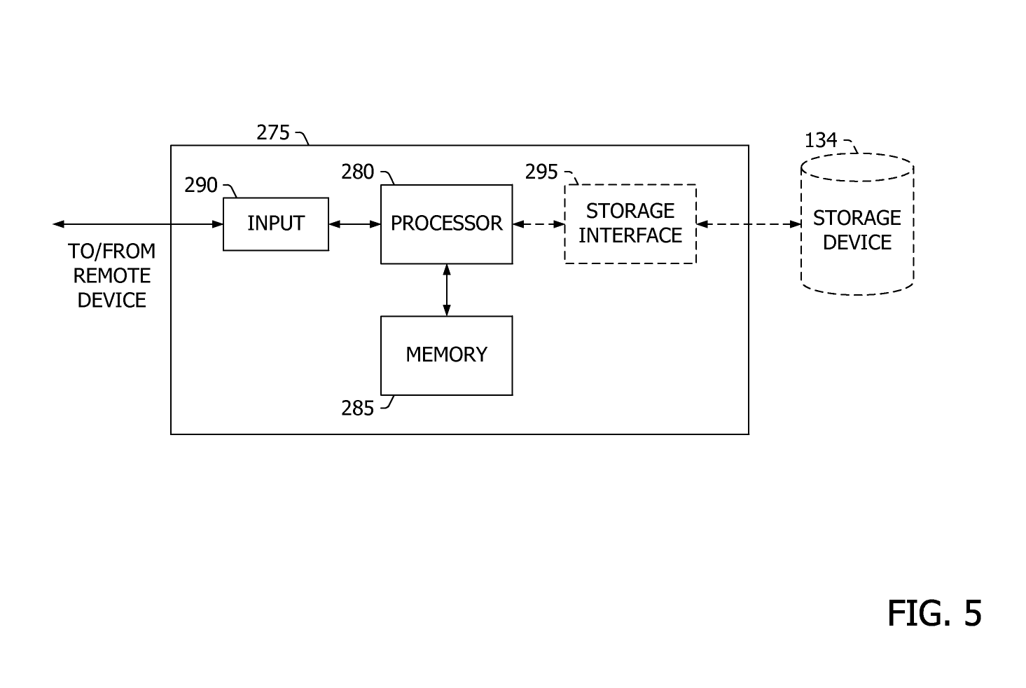

FIG. 5 illustrates an example configuration of a server computer device 275 such as server system 112 (shown in FIGS. 2 and 3). Server computer device 275 may include, but is not limited to, database server 116, transaction server 124, web server 126, fax server 128, directory server 130, and mail server 132.

Server computer device 275 includes a processor 280 for executing instructions. Instructions may be stored in a memory area 285, for example. Processor 280 may include one or more processing units (e.g., in a multi-core configuration).

Processor 280 is operatively coupled to a communication interface 290 such that server computer device 275 is capable of communicating with a remote device such as cardholder computer device 202 (shown in FIG. 4) or another server computer device 275. For example, communication interface 290 may receive requests from client systems 114 or vehicle computer device 118 via the Internet, as illustrated in FIGS. 2 and 3.

Processor 280 may also be operatively coupled to a storage device 134. Storage device 134 is any computer-operated hardware suitable for storing and/or retrieving data. In some embodiments, storage device 134 is integrated in server computer device 275. For example, server computer device 275 may include one or more hard disk drives as storage device 134. In other embodiments, storage device 134 is external to server computer device 275 and may be accessed by a plurality of server computer devices 275. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 280 is operatively coupled to storage device 134 via a storage interface 295. Storage interface 295 is any component capable of providing processor 280 with access to storage device 134. Storage interface 295 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 280 with access to storage device 134.

Memory area 285 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

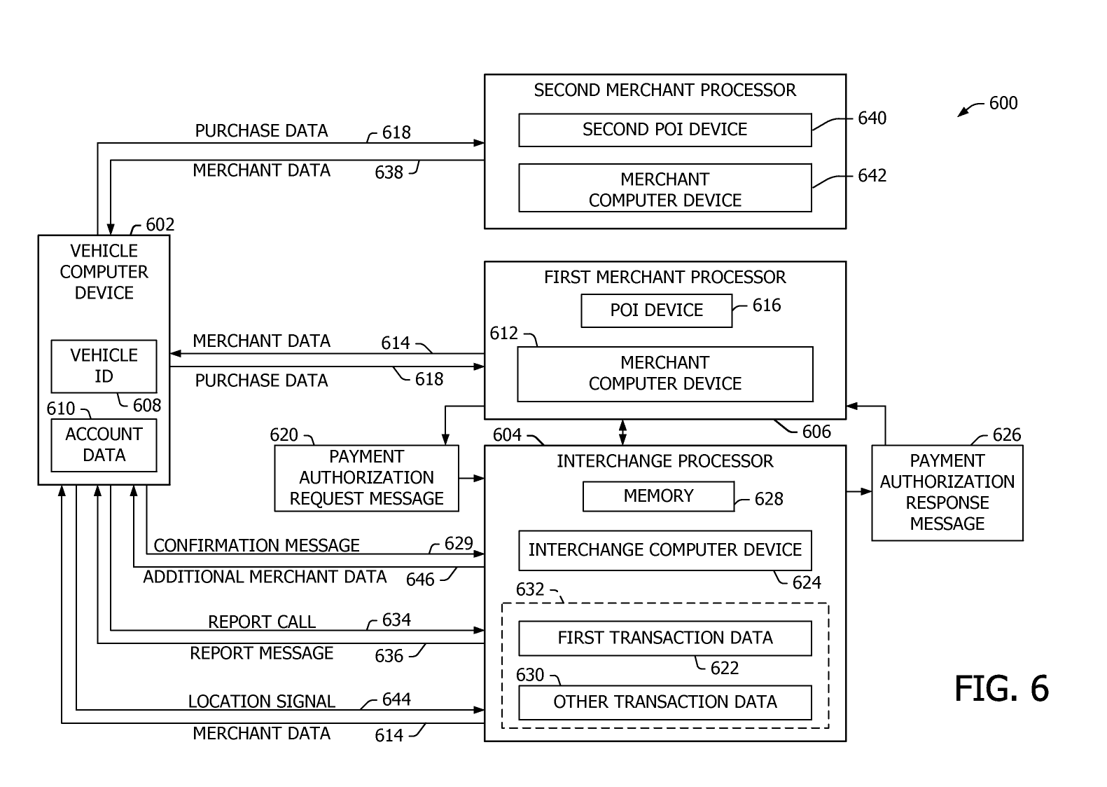

FIG. 6 is a block diagram of a payment account processing system 600 showing data flow among a vehicle computer device 602, such as cardholder computer device 118 (shown in FIGS. 2 and 3), a payment processor 604, and a merchant processor 606. In the example embodiment, system 600 may be a payment account processing system such as payment network system 122 (shown in FIGS. 1 and 2). In some embodiments, payment processor 604 may be an interchange network. In one embodiment, cardholder computer device 602 is integrated within the user's vehicle and/or coupled to the user's vehicle. More particularly, cardholder computer device 602 is a component of the user's vehicle and therefore may be referred to as a vehicle computer device. The vehicle can include any configuration to enable mobility for vehicle computer device 602. Vehicle computer device 602 is configured to allow a cardholder to access payment processor 604 and merchant processor 606 and electronically transact with payment processor 604 and merchant processor 606 to purchase items/services associated with the merchant and offered for sale and/or offered for lease by the merchant. In the example embodiment, cardholder computer device 602 is associated with a vehicle, such as, but not limited to, an automobile, a truck, a recreational vehicle, a motorcycle and a marine vessel. Moreover, vehicle computer device 602 includes a vehicle identifier 608 which includes a specific identifier, such as a number, to identify the vehicle to facilitate associating the particular vehicle with payment card or purchases or with a particular purchased item. Different vehicles are assigned unique vehicle identifiers 608 to associate the transactions to the particular vehicle. Regardless of which cardholder and account data 610 are used to purchase the item, the purchased item is associated with the vehicle via vehicle identifier 608. Account data 610 includes data identifying a payment card issued to cardholder by an issuing bank. In one embodiment, account data 610 is stored on vehicle computer device 602. Moreover, in one embodiment, account data 610 includes multiple payment cards that are issued by issuing bank, wherein multiple payment cards are associated with different users associated with cardholder such as cardholder's spouse and/or dependents.

Merchant processor 606 includes a merchant computer device 612. In the example embodiment, merchant computer device 612 may be a computer device such as cardholder computer device 202 (shown in FIG. 4). Merchant computer device 612 is a device that is communicatively coupled to merchant processor 606. Merchant computer device 612 allows merchant processor 606 to communicate first merchant data 614 to vehicle computer device 602. In the example embodiment, processor 604 also includes a point of interaction device 616 (POI device) such as a transmitter/receiver device. POI device 616 is configured to transmit first merchant data 614 via at least one a cellular transmission, a Wi-Fi transmission and a Bluetooth transmission. POI device 616 is configured to transmit first merchant data 614 in any configuration that enables merchant processor 606 to function as described herein. Moreover, POI device 616 is configured to continuously transmit first merchant data 614 within a predetermined distance as measured from merchant processor 606. For example, POI device 616 can transmit first merchant data 614 up to ten miles from the location of merchant processor 606. Alternatively, POI device 616 can transmit first merchant data 614 to any distance based on the transmission strength of POI device 616. Alternatively, POI device 616 can transmit first merchant data 614 at predetermined time periods and/or upon activation by a sensor such as, for example, a motion sensor. For example, when the vehicle activates a motion sensor such as by entering a restaurant drive-through lane, POI device 616 is configured to transmit first merchant data 614 to vehicle computer device 602.

First merchant data 614 includes information related to a plurality of items such as goods and/or services offered for sale and/or offered for lease by merchant and stored on computer device 612. In one embodiment, first merchant data 614 includes data of the plurality of items such as, but not limited to, the merchant's name, the merchant's location, the merchant's product/service menu and/or the merchant's pricing for goods and/or services. More particularly, first merchant data 614 includes a restaurant menu, pricing and special offers. First merchant data 614 includes any data that provides merchant information offered for sale and/or offered for lease by merchant to vehicle computer device 602.

Vehicle computer device 602 is configured to receive first merchant data 614 transmitted by POI device 616. In the example embodiment, vehicle computer device 602 is configured to receive at least first merchant data 614 by one of a cellular transmission, a Wi-Fi transmission and a Bluetooth transmission, when vehicle computer device 602 is located within a predetermined distance of merchant computing device 612 such as when vehicle computer device 602 enters the transmission distance of POI device 616. Vehicle computer device 602 is configured to continuously receive the transmission of first merchant data 614. Alternatively, vehicle computer device 602 is configured to receive first merchant data 614 upon activation by the user and/or at predetermined times such as, for example, during a lunch time period. Vehicle computer device 602 is further configured to display at least some of first merchant data 614 to user on a user display coupled to vehicle computer device 602. Moreover, vehicle computer device 602 is configured to prompt the cardholder to select a purchased item from the plurality of purchase items of first merchant data 614.

Vehicle computer device 602 is configured to receive at least one of vehicle identifier 608 and account data 610 provided by the user. Upon interaction by the user, vehicle computer device 602 transmits purchase data 618 to merchant processor 606 after receiving first merchant data 614 from merchant computer device 612. Purchase data 618 includes purchase item data having information responsive to first merchant data 614, (i.e., purchase data 618 indicates a purchase instruction associated with the goods/services a cardholder would like to purchase from the merchant such as the purchased item of the plurality of purchased items of first merchant data 614.) Moreover, purchase data 618 includes vehicle identifier 608 associated with the vehicle and account data 610 associated with the cardholder. Account data 610 can include credential information data of the cardholder for an associated payment card. In one embodiment, purchase data 618 includes a food order based on the transmitted menu of first merchant data 614. In the example embodiment, vehicle computer device 602 is configured to transmit purchase data 618 to merchant processor 606 by at least one of a cellular transmission, a Wi-Fi transmission and a Bluetooth transmission. Vehicle computer device 602 is configured is to transmit purchase data 618 to merchant processor 606 in any configuration to enable vehicle computer device 602 to function as described herein.

When merchant processor 606 receives purchase data 618, merchant computer device 612 generates a payment authorization request message 620. Payment authorization request message 620 is transmitted to an interchange computer device 624 coupled to payment processor 604 as a first transaction data 622 for processing and further transmission to an issuing bank for approval. First transaction data 622 include at least vehicle identifier 608 associated with the vehicle, account data 610 associated with the cardholder and purchase data 618 associated with a purchased item. A payment authorization response message 626 is received from the issuing bank by interchange computer device 624 and transmitted to merchant computer device 612. Additionally, first transaction data 622 are stored at memory 628 of payment processor 604 after the transaction is processed by the issuing bank. Vehicle computer device 602 is configured to receive a confirmation message 629 in response to payment authorization response message 626 confirming the issuing bank authorized the transaction of purchase data 618.

In the example embodiment, interchange computer device 624 is configured to store first transaction data 622 which includes metric data such as, for example, vehicle identifier 608, account data 610 and purchase data 618. Interchange computer device 624 is configured to store and/or track other transaction data 630 associated with other purchased items by vehicle computer device 602. First transaction data 622 and other transaction data 630 define a total transaction data 632 associated with the vehicle. Moreover, interchange computer device 624 is configured to track, categorize, organize, and/or analyze first transaction data 622 and/or total transaction data 632 and further associate stored first transaction data 622 and/or total transaction data 632 with at least one of vehicle identifier 608 and account data 610 for access by the cardholder via vehicle computer device 602.

In the example embodiment, interchange computer device 624 is configured to aggregate a monetary value of the stored purchase data 618 and/or stored first transaction data 622 and/or total transaction data 632 over a period of time. Interchange computer device 624 can also analyze consumption of purchase data 618 and/or stored first transaction data 622 and/or total transaction data 632 over a period of time and/or over an amount of distance traveled by the vehicle. For example, interchange computer device 624 is configured to store purchase data 618 such as food purchased during a particular month and transmit to vehicle computer device 602 a record of the type of food purchased, the amount of food purchased and/or a monetary amount of food purchased.

Interchange computer device 624 stores transaction data 622 and/or total transaction data 632 including at least vehicle identifier 608, account data 610 and purchase data 618 for the selected vehicle computer device 602. The cardholder may view transaction data 622, 632 by transmitting a report call 634 from vehicle computer device 602 to interchange computer device 614 and request a report message 636 to interchange computer device 624. Report message 636 includes a record of stored first transaction data 622 and/or total transaction data 632 associated with at least one vehicle computer device 602, vehicle identifier 608 and account data 610.

Vehicle computer device 602 is configured to receive report message 636 from interchange computer device 624 and display report message 636 using a media/display output device of vehicle computer device 602. More particularly, interchange computer device 624 is configured to transmit report message 636 including first transaction data 622 and/or total transaction data 632 to vehicle computer device 602. Vehicle computer device 602 is configured to receive report message 636 including first transaction data 622 and/or total transaction data 632 from interchange computer device 624 for display to the cardholder.

In some embodiments, vehicle computer device 602 is configured to receive a second merchant data 638 that is transmitted from a second POI device 640 coupled to a second merchant processor 642. Second merchant data 638, second POI device 640 and second merchant processor 642 are different than first merchant data 614, first merchant POI device 616 and first merchant processor 606. Vehicle computer device 602 is configured to compare first merchant data 614 with second merchant data 638 and select at least one of first merchant data 614 and second merchant data 638. For example, vehicle computer device 602 is configured to receive first merchant data 614 of a first restaurant menu and a second merchant data 638 of a second restaurant menu, wherein vehicle computer device 602 is configured to display to the user first and second merchant data 614, 638 for comparison. Alternatively, vehicle computer device 602 is configured to compare embedded data (i.e., pricing) within first and second merchant data 614, 638 and display the comparison to the user. The user interacts with vehicle computer device 602 to instruct vehicle computer device 602 to select at least one of first merchant data 614 and second merchant data 638 and transmit purchase data 618 to at least one of first merchant processor 606 and second merchant processor 642.

In another embodiment, vehicle computer device 602 is configured to transmit a location signal 644 to interchange computer device 624. Vehicle computer device 602 can continuously transmit location signal 644 to interchange computer device 624. Alternatively, vehicle computer device 624 can transmit location signal 644 to interchange computer device 624 upon activation by the user and/or at predetermined time periods such as lunch time periods.

Interchange computer device 624 is configured to receive location signal 644 and associate the location of the vehicle computer device 602 with a plurality of merchants. More particularly, the vehicle's location, via location signal 644, is associated with the plurality of merchants within a predetermined distance from the vehicle location. Merchants that are registered with payment network system 122 transmit respective first merchant data 614 to interchange computer device 624 for storage on memory 628. Interchange computer device 624 is configured to categorize first merchant data 614 such as, for example, by at least one of a food establishment, a retail establishment and a service establishment.

Interchange computer device 624 is configured to transmit first merchant data 614 of the plurality of merchants located within the predetermined distance of the vehicle location to vehicle computer device 602. Interchange computer device 624 can continuously transmit first merchant data 614 to vehicle computer device 602. Alternatively, interchange computer device 624 can transmit first merchant data 614 upon a request transmission from vehicle computer device 602 and/or can transmit first merchant data 614 for a predetermined time period such as a lunch time period.

First merchant data 614 includes at least one of a merchant's name, a merchant's location including directions from the location of vehicle computer to merchant, a merchant's product menu, a merchant's service menu and/or a merchant's pricing. Moreover, interchange computer device 624 is configured to transmit first merchant data 614 that is associated with a predetermined distance from vehicle computer device 602. For example, when interchange computer device 602 correlates location signal 644 with a geographic area of vehicle, interchange computer device 624 is configured to retrieve from memory 628 first merchant data 614 associated with merchants located within the predetermined distance (i.e., ten miles) of the geographic area.

Merchants can update first merchant data 614 stored within memory 628 by transmitting to interchange computer device 624 additional merchant data 646 such as, but not limited to, coupon data, promotional data, sales data and new items/services data. Interchange computer device 624 is configured to transmit to vehicle computer device 602 additional merchant data 646 such as coupon data that is associated with first merchant data 614.

Upon interaction by the user, vehicle computer device 602 transmits purchase data 618 to merchant computer device 612 after receiving first merchant data 614 from interchange computer device 624. Purchase data 618 includes information responsive to first merchant data 614, i.e., purchase data 618 indicates a purchase instruction associated with the goods/services offered for sale and/or offered for lease by merchant and a cardholder would like to purchase from the merchant. In one embodiment, purchase data 618 includes a food order based on the transmitted menu of first merchant data 614. In the example embodiment, vehicle computer device 602 is configured to transmit purchase data 618 to merchant computer device 612 by at least one of a cellular transmission, a Wi-Fi transmission and a Bluetooth transmission. Vehicle computer device 602 is configured is to transmit purchase data 618 to merchant processor 606 in any configuration to enable vehicle computer device 602 to function as described herein.

When merchant processor 606 receives purchase data 618, merchant computer device 612 generates payment authorization request message 620. Payment authorization request message 620 is transmitted to interchange computer device 624 as first transaction data 622 for processing and for further transmission to an issuing bank for approval. First transaction data 622 include at least vehicle identifier 608 associated with the vehicle, account data 610 associated with the cardholder and purchase data 618 associated with a purchased item of the plurality of purchase items of first merchant data 614 offered for sale and/or offered for lease by merchant. A payment authorization response message 626 is received from the issuing bank and transmitted to merchant computer device 612 by interchange computer device 624. Additionally, first transaction data 622 are stored at payment processor 604 after the transaction is processed by the issuing bank.

Interchange computer device 624 stores transaction data 622 and/or total transaction data 632 including at least vehicle identifier 608, account data 610 and purchase data 618 for the selected vehicle computer device 602. The cardholder may view transaction data 622, 632 by transmitting report call 634 from vehicle computer device 602 and request report message 636 to interchange computer device 624, wherein report message 636 includes a record of stored transaction data 622 and/or total transaction data 632 including purchase data 618 associated with vehicle computer device 602.

In some embodiments, vehicle computer device 602 is configured to receive second merchant data 638 coupled to second merchant processor 642 that is transmitted from interchange computer device 624. Vehicle computer device 602 is configured to compare first merchant data 614 with second merchant data 638 and select at least one of first merchant data 614 and second merchant data 638. For example, vehicle computer device 602 is configured to receive first merchant data 614 of a first restaurant menu and second merchant data 638 of a second restaurant menu, wherein vehicle computer device 602 is configured to display to the user first and second merchant data 614, 638 for comparison. Alternatively, vehicle computer device 602 is configured to compare embedded data (i.e., pricing) within first and second merchant data 614, 638 and display the comparison to the user. The user interacts with vehicle computer device 602 to instruct vehicle computer device 602 to select at least one of first merchant data 614 and second merchant data 638 and transmit purchase data 618 to at least one of first merchant processor 606 and second merchant processor 642.

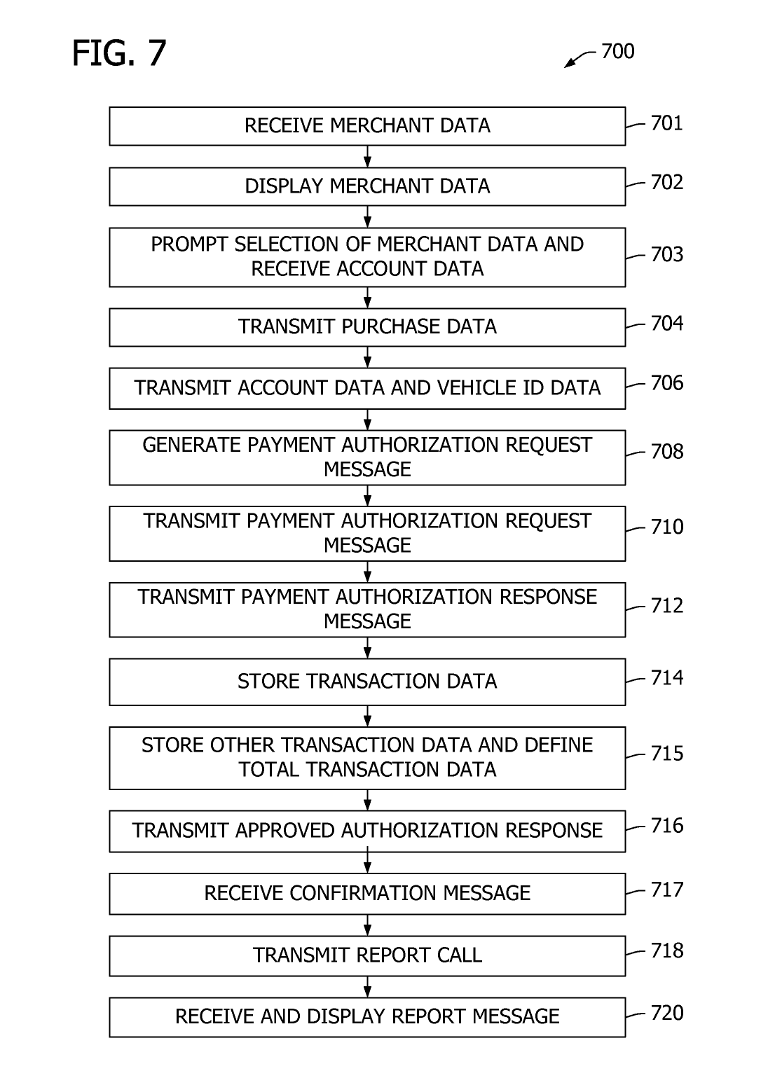

FIG. 7 is a flowchart illustrating an example process 700 for using a cardholder computer device, such as vehicle computer device 602 (shown in FIG. 6), when performing a transaction in accordance with one embodiment of the present invention. In one embodiment, process 700 may be implemented by system 100 (shown in FIG. 2). In the example embodiment, process 700 relates to the receiving and transmitting of messages and information among vehicle computer device 602, merchant computer device 612, and interchange computer device 624 (all shown in FIG. 6). While operations within the process 700 are described below with regard to particular devices and/or systems, process 700 may be implemented on other such devices and/or systems by one skilled in the art.

During operation, vehicle computer device 602 receives 701 first merchant data 614 from POI device 616 of merchant computer device 612 when the vehicle is located within a predetermined distance of merchant computer device 612. First merchant data 614 includes the plurality of items offered for sale and/or offered for lease by the merchant. The user display device that is coupled to vehicle computer device 602 displays 702 at least some of first merchant data 614 to vehicle computer device 602. The cardholder is prompted 703 to select a purchased item of the plurality of purchased items of first merchant data 614. Upon initiation by the cardholder, vehicle computer device 602 receives account data 610. Further, upon initiation by the cardholder, vehicle computer device 602 transmits 704 purchase data 618 to merchant computer device 612. Vehicle computer device 602 also transmits 706 vehicle identifier 608, account data 610 and purchase data 618 to merchant computer device 612.

Merchant computer device 612 then generates 708 payment authorization request message 620 and first transaction data 622 which includes at least some of vehicle identifier 608, account data 610 and purchase data 618. Payment authorization request message 620 is transmitted 710 from merchant computer device 612 to interchange computer device 624 for processing and further transmission to an issuing bank for approval. Interchange computer device 624 receives 712 payment authorization response message 626 from the issuing bank either approving or denying the transaction. When the issuing bank approves the transaction, first transaction data 622 are stored 714 at the interchange computer device 624. Other transaction data 630 associated with other purchased items for the vehicle are stored 715 at interchange computer device 624, wherein first transaction data 622 and other transaction data 630 define total transaction data 632. Total transaction data 632 is tracked, via vehicle identifier 608, by interchange computer device 624 for access by the cardholder. The approved payment authorization response message 626 is transmitted 716 to merchant computer device 612 so that the transaction can be completed with the cardholder. Vehicle computer device 602 receives 717 confirmation message 629 in response to authorized request message 620 that the issuing bank authorized the transaction.

The cardholder is able to receive details regarding previous transactions by transmitting 718 report call 634 from vehicle computer device 602 to interchange computer device 624. In the example embodiment, the selected vehicle is identified by vehicle identifier 608. The cardholder receives 720 report message 636 from interchange computer device 624 and displays the message using vehicle computer device 602.

In some embodiments, one or more messages sent between the different computer systems, or a portion thereof, are encrypted by the sending device and decrypted by the receiving device. For example, the payment authorization response message may be encrypted by the express check out platform and decrypted by the merchant computer. In one embodiment, the interchange computer system encrypts an account number (e.g., a PAN) using a public key assigned to the merchant, and the merchant computer system decrypts the account number using a private key corresponding to the public key. For example, the private key and the public key may be assigned to the merchant by the interchange network for use in signing documents and/or messages, and may also be used for encrypting messages transmitted between the merchant and the interchange network.

While the invention has been described in terms of various specific embodiments, those skilled in the art recognize that the invention can be practiced with modification within the spirit and scope of the claims.

Example embodiments of methods, systems, and computer-readable storage media for use in implementing an electronic transaction processing system are described above in detail. The methods, systems, and storage media are not limited to the specific embodiments described herein but, rather, operations of the methods and/or components of the system may be utilized independently and separately from other operations and/or components described herein. Further, the described operations and/or components may also be defined in, or used in combination with, other systems, methods, and/or storage media, and are not limited to practice with only the methods, systems, and storage media as described herein.

A computing device, such as those described herein, includes at least one processor or processing unit and a system memory. The computing device typically has at least some form of computer readable media. By way of example and not limitation, computer readable media include computer storage media and communication media. Computer storage media include volatile and nonvolatile, removable and non-removable physical media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

The methods described herein may be encoded as executable instructions embodied in a computer readable medium, including, without limitation, a computer storage medium, a storage device, and/or a memory device. Such instructions, when executed by a processor, cause the processor to perform at least a portion of the methods described herein.

Although the present invention is described in connection with an example electronic transaction processing system environment, embodiments of the invention are operational with numerous other general purpose or special purpose electronic transaction processing system environments or configurations. The electronic transaction processing system environment is not intended to suggest any limitation as to the scope of use or functionality of any aspect of the invention. Moreover, the electronic transaction processing system environment should not be interpreted as having any dependency or requirement relating to any one or combination of components illustrated in the example operating environment. Examples of well-known electronic transaction processing systems, environments, and/or configurations that may be suitable for use with the embodiments described herein include, but are not limited to, embedded computing devices, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments may be described in the general context of computer-executable instructions, such as program components or modules, executed by one or more computers, processors, and/or other devices. Aspects of the invention may be implemented with any number and organization of components or modules. For example, embodiments are not limited to the specific computer-executable instructions or the specific components or modules illustrated in the figures and described herein. Alternative embodiments may include different computer-executable instructions or components having more or less functionality than illustrated and described herein.

The order of execution or performance of the operations in the embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the described embodiments.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal languages of the claims.

What is claimed is:

1. A computer-implemented method for performing an electronic transaction over a payment network system, the payment network system including a payment card account system having a server system coupled to a memory device, the transaction initiated by a cardholder using a cardholder computer device in communication with a merchant computer device of a merchant, the cardholder computer device associated with a vehicle, said method comprising:
receiving first merchant data at the cardholder computer device when the vehicle is located within a predetermined distance of the merchant computer device, the first merchant data including a plurality of items offered for sale by the merchant;
displaying at least some of the first merchant data on a user display coupled to the cardholder computer device;
prompting the cardholder to select a purchase item from the plurality of items;
receiving account data at the cardholder computer device;
transmitting purchase data including at least one of an account data and a purchase item data to the merchant computer device, wherein the merchant computer device is configured to generate a payment authorization request message for providing to an issuing bank based at least in part on the purchase data; and
receiving, at the cardholder computer device, a confirmation message in response to the authorization request message confirming that the issuing bank authorized the transaction.

2. The computer-implemented method in accordance with claim 1, wherein the cardholder computer device is integrated within the vehicle.

3. The computer-implemented method in accordance with claim 1, wherein the account data includes data identifying a payment card issued to the cardholder by an issuing bank.

4. The computer-implemented method in accordance with claim 1, further comprising prompting the cardholder to select a payment card and enter a security credential associated with the selected payment card.

5. The computer-implemented method in accordance with claim 1, wherein the purchase data includes a vehicle identifier.

6. The computer-implemented method in accordance with claim 1, wherein the account data account is stored on the cardholder computer device.

7. The computer-implemented method in accordance with claim 1, further comprising transmitting, from the cardholder computer device, a call report to request transaction data from server system, the transaction data including data associated with purchases made associated with the vehicle.

8. The computer-implemented method in accordance with claim 1 further comprising receiving, at the cardholder computer device, the first merchant data transmitted by a point of interaction device of the merchant computer device by receiving at least one a cellular transmission, a Wi-Fi transmission and a Bluetooth transmission.

9. The computer-implemented method in accordance with claim 1, further transmitting the purchase data, from the cardholder computer device, by at least one a cellular transmission, a Wi-Fi transmission and a Bluetooth transmission.

10. The computer-implemented method in accordance with claim 1, further comprising continuously receiving, at the cardholder computer device, the first merchant data.

11. The computer-implemented method in accordance with claim 1, further comprising receiving, at the cardholder computer device, the first merchant data for a predetermined period of time.

12. The computer-implemented method in accordance with claim 1, further comprising receiving, at the cardholder computer device, a coupon data associated with the first merchant data.

13. The computer-implemented method in accordance with claim 1, further comprising receiving, at the cardholder computer device, a second merchant data that is transmitted from a second point of interaction device of a second merchant.

14. The computer-implemented method in accordance with claim 1, further comprising receiving, at the cardholder computer device, a second merchant data that is transmitted from a second point of interaction device of the second merchant and comparing the first merchant data with the second merchant data.

15. A computer-implemented method for performing an electronic transaction over a payment network system, the payment network system including a server system coupled to a memory device, the transaction initiated by a cardholder using a cardholder computer device in communication with a merchant computer device of a merchant, said method comprising:
receiving, at the server system, a transmission of a location signal of the cardholder computer device;
associating, at the server system, the location signal of the cardholder computer device with a plurality of merchant data stored within the database of the interchange computer;
transmitting a first merchant data of the plurality of merchant data from the interchange computer to the cardholder computer device;
receiving, at the server system, an authorization request message from a merchant associated with the first merchant data, the authorization request message comprising the first merchant data and an account data associated with the cardholder;
transmitting an authorization response message from the server system to the merchant associated with the first merchant data; and
storing the first merchant data and the account data.

16. The computer-implemented method in accordance with claim 15, further comprising categorizing, at the server system, the first merchant data by at least one of a retail establishment, a food establishment and a vehicle service establishment.

17. The computer-implemented method in accordance with claim 15, further comprising transmitting from the server system and to the cardholder computer device a coupon data associated with the first merchant data.

18. The computer-implemented method in accordance with claim 15, further comprising transmitting from the server system and to the user computer the first merchant data associated with the merchant located within a predetermined distance from the location signal of the cardholder computer device.

19. The computer-implemented method in accordance with claim 15, further comprising transmitting from the server system and to the user computer the first merchant data for a predetermined period of time.

20. The computer-implemented method in accordance with claim 15, further comprising transmitting from the server system and to the user computer a direction instruction of the merchant associated with the first merchant data.

21. The computer-implemented method in accordance with claim 15, further comprising transmitting from the server system and to the user computer the first merchant data comprising at least one of merchant name, a merchant location, a merchant product menu and a merchant service menu.

22. The computer-implemented method in accordance with claim 15, wherein the cardholder computer device is integrated with a vehicle.

23. A vehicle computer device integrated with a vehicle for performing an electronic transaction over a payment network system, the payment network system including a server system coupled to a memory device, the transaction initiated by a cardholder using the vehicle computer device in communication with a merchant computer device of a merchant, said vehicle computer device programmed to:
receive the first merchant data when the vehicle is located within a predetermined distance of the merchant computer device, the first merchant data including a plurality of items offered for sale by the merchant;
display at least some of the first merchant data on a user display coupled to the vehicle computer device;
prompt the cardholder to select a purchase item from the plurality of items;
receive account data associated with the cardholder;
transmit purchase data including at least one of an account data and a purchase item data to the merchant computer device, wherein the merchant computer device is configured to generate a payment authorization request message for providing to an issuing bank based at least in part on the purchase data; and
receive a confirmation message in response to the authorization request message confirming that the issuing bank authorized the transaction.

24. The vehicle computer device in accordance with claim 23, further programmed to receive the transmission of the first merchant data from a point of interaction device of the merchant.

25. The vehicle computer device in accordance with claim 23, further programmed to receive the transmission of the first merchant data from the server system.

26. The vehicle computer device in accordance with claim 23, further programmed to receive the transmission of the first merchant data comprising at least one of a cellular transmission, a Wi-Fi transmission and a Bluetooth transmission.

27. The vehicle computer device in accordance with claim 23, further programmed to transmit the purchase data comprising at least one of a cellular transmission, a Wi-Fi transmission and a Bluetooth transmission.

28. One or more non-transitory computer-readable storage media having computer-executable instructions embodied thereon for performing an electronic transaction over a payment network system, the payment network system including a server system coupled to a database, the transaction initiated by a cardholder using a cardholder computer device in communication with a merchant computer device of a merchant, the cardholder computer device associated with a vehicle, wherein the server system includes a memory device and a processor, wherein when executed by said processor, said computer-executable instructions cause said processor to:
receive a transmission of a location signal of the cardholder computer device;
associate the location signal of the cardholder computer device with a plurality of merchant data stored within the database of the server system;
transmit a first merchant data of the plurality of merchant data from the server system to the cardholder computer device;
receive an authorization request message from a merchant associated with the first merchant data, the authorization request message comprising the first merchant data and an account data associated with the cardholder;
transmit an authorization response message from the server system to the merchant associated with the first merchant data; and
store the first merchant data and the account data.

29. A system for performing an electronic transaction over a payment network system, the payment network system including a server system coupled to a memory device, the transaction initiated by a cardholder with a merchant computer device of a merchant, said system comprising:
a vehicle computer device integrated with a vehicle and configured to:
receive a first merchant data when the vehicle is located within a predetermined distance of the merchant computer device, the first merchant data including a plurality of items offered for sale by the merchant;
display at least some of the first merchant data on a user display coupled to the vehicle computer device;
prompt the cardholder to select a purchase item from the plurality of items;
receive account data associated with the cardholder;
transmit purchase data including at least one of an account data and a purchase item data to the merchant computer device, wherein the merchant computer device is configured to generate a payment authorization request message for providing to an issuing bank based at least in part on the purchase data; and
receive a confirmation message in response to the authorization request message confirming that the issuing bank authorized the transaction.

30. The system of claim 29, further comprising a server system configured to:
receive a payer authorization request message from the merchant, the payer authorization request message including the first merchant data and the purchase data;
transmit a payer authorization response message to the merchant; and
store the first merchant data and the purchase data.
